(19) United States
(12) Patent Application Publication
(10) Pub. No.: US 2007/0143428 A1
(43) Pub. Date: Jun. 21, 2007

(54) Method and system for displaying indications of messages from important persons and from new persons at a high display priority in a gathered threads view of an electronic mail ("email") user interface

(76) Inventors: Shruti Kumar, Littleton, MA (US); Niklas Heidloff, Salzkotten (DE); Michael R. O'Brien, Westford, MA (US); Paul L. Wilson, Cambridge, MA (US)

Correspondence Address: LOTUS AND RATIONAL SOFTWARE;McGuinness & Manaras LLP, 125 NAGOG PARK, ACTON, MA, 01720, US

(21) Appl. No.: 11/314,778

(22) Filed: Dec. 21, 2005

(51) Int. Cl. G06F 15/16

(52) U.S. Cl. 709/206

(57) ABSTRACT

A system for providing a gathered threads view of email messages that effectively indicates the presence of messages from important persons and/or from new participants in the thread. When a message in a thread is received, the sender of the message is compared to a list of important persons for the receiving user. If the message is from a person that is important to the receiving user, then an indication of that message is presented in the user interface with a higher display precedence than indications of messages in the thread from users that are not important. The sender of a received message in a thread may also be compared with the senders of previous messages in the thread and the recipients of the first message in the thread. If the sender of the received message is a person that has not previously been a sender of a previous message in the thread, then that message is considered to be from a new participant in the thread, and an indication of the received message is presented in the user interface with a higher display precedence than indications of messages in the thread sent from persons that had previously been senders. The system may display indications of all messages in a thread received from important persons are displayed at a higher precedence than indications of messages from new thread participants, which are in turn displayed at a higher precedence than indications of all other messages in the thread.

### FIELD OF THE INVENTION

The present invention relates generally to electronic messaging systems, such as electronic mail (“email”), and specifically to a method and system for displaying indications of messages from important persons and from new persons at a high display priority in a gathered threads view of an electronic mail (“email”) user interface.

### BACKGROUND OF THE INVENTION

Electronic messaging systems, such as electronic mail (“email”), have become ubiquitous for both business and personal use. Examples of email applications include Microsoft® Outlook, Eudora, and Web based email systems provided through an Internet browser program, such as services provided by Google, Yahoo, and other Web portal providers. Email systems are often architected in a client-server software model, in which client software is provided in end user computer systems to enable users to compose, send and receive messages, while a server software component is provided to perform various centralized functions.

Typical email applications provide a user with a graphical user interface through which messages can be composed and sent, and through which messages can also be received. A number of mailbox constructs are usually maintained for the user, including an Inbox to store received messages, an Outbox into which messages are put pending being sent, and a Sent mailbox for storing messages that have previously been transmitted. An email message usually includes or is associated with a list of destination addresses or user names identifying recipients to which the message is to be delivered, sometimes known as a “To:” field. A “From:” field is also included or associated with a message, and identifies the sender of the message. A “Subject:” field for an email message includes a text string defining the subject of the message. A message body contains the content of the message, including text, images, links, or other content. A number of separate documents may also be attached to the message before it is sent, containing additional content to that contained within the message body. After the message body, destination email addresses, and any attachments to the message are defined, the user can click on a “Send” button or the like to cause the message to be sent.

When a message is received, the email client software provides the receiving user with the ability to reply to the received message, for example by way of a “Reply” and/or “Reply All” button within the graphical user interface. Clicking on the “Reply” button sets up a new message, including the received message, for editing and sending back to the original sender of the received message. Clicking on the “Reply All” button also sets up a new message, also including the received message, for editing and sending back to the original sender and any other recipients of the original message. A reply that is sent including all previous message information is sometimes referred to as a “reply with history”. The original sender, or any other recipient of a reply message, may then similarly generate another reply.

A series of received messages that are direct or indirect replies to an original “root” message may be referred to as a message “thread”. The reply messages in a thread may be considered child messages under the original root message. In addition to the reply messages, a thread may or may not be considered to also include the original root message. In an email system, a thread may consist of a number of received messages stored in a user's Inbox, or another mailbox structure provided by the email system. Messages within a thread may be transmitted or received over potentially long periods of time, and a thread may sit dormant for a time period before it is resumed when a new message is added to it.

Existing email systems have attempted to display message threads in a user friendly way by using what are referred to as “gathered” threads views. For example, in a gathered threads view, received messages belonging to a thread may be represented using a single message entry in the user's Inbox. One example of a gathered threads view of message threads is found in the “conversations” view displayed by the Gmail™ email system from Google®.

FIG. 1 is a simplified screen shot showing an example of a gathered thread view as might be presented by an existing system. As shown in FIG. 1, a screen shot 10 includes a threads list 12 of message thread entries, each of which represents multiple messages within a thread. Each entry in the list 12 includes a sender list 14 containing the user names of senders of corresponding messages in the thread. A number in parenthesis at the end of each sender list indicates the total number of messages in the thread. Because of display space constraints, the displayed sender list 14 for a given entry in the list 12 may only represent a subset of the total number of messages in the thread. The user names that are displayed in the sender list 14, may, for example, be presented by showing just the senders of the first and last messages in the thread, senders of some number of the most recent messages in the thread, or senders of some number of oldest messages in the thread. Each entry in the sender list 14 may further include a subject field 16 showing a subject shared across the messages in the associated thread. However, the messages in a thread need not necessarily all have the same subject field text.

For example, in the gathered threads view 10 of FIG. 1, each entry shows the senders for the first and last messages in the corresponding thread. Accordingly, with regard to the entry 18, the associated thread includes three messages: a first message received from George, a last message received from Emily, and another message whose sender is not shown, all regarding a subject of “software project”. In some systems, if the user clicks on the sender list 14 for a given entry, the corresponding thread is expanded in the display to show all messages contained in the thread.

A problem in existing gathered thread views results from the fact that the sender list for a thread represents the messages in the thread and their corresponding senders based only on the order in which the messages were received. As a result, if the number of messages in a thread exceeds the maximum number of senders displayed in the sender list 14 (which in some cases may only be the sender of the most recent message and/or of the original message), many senders of messages in the thread are potentially hidden from the user. This forces the user to expand the thread to determine whether any messages have been received from important senders, or whether any new participants have joined the thread.

For example, again with reference to FIG. 1, the thread for entry 20 includes ten messages, as indicated by the parenthetical number “(10)” in the entry 20, but only the senders for the first and last messages in the thread are visible to the user. The senders of the other eight messages in the thread are invisible to the user. This is a problem if one or more of those invisible senders are persons considered important to the user. For example, if one of the eight senders not displayed in the entry 20 is from the lead architect of the software project that is the subject of the thread, then the user may need to be aware of the presence of that message in the thread without having to expand the view of the thread. Additionally, a user may desire to be made aware of any messages in thread sent by a new thread participant. In existing systems such as that shown in FIG. 1, if a message from a new thread participant is not one of the subset of the messages represented by senders displayed in the visible portion of the sender list, the user would be unaware the presence of that message in the thread, and therefore unaware that the new participant had joined the thread.

For these reasons and others, it would be desirable to have a new system for providing a gathered threads view that displays indications of messages received from important persons and new thread participants so that the user is conveniently made aware of the presence of such messages in a thread without having to expand the thread or individual messages in the thread.

### SUMMARY OF THE INVENTION

To address the above described and other deficiencies of previous approaches, a method and system for providing a gathered threads view of email messages that effectively indicates the presence of messages from important persons and/or from new thread participants. In the disclosed system, when a message in a thread is received, the sender of the message is compared to a list of important persons for the receiving user. If the message is determined to be from a person that is important to the receiving user, then an indication of the sender of that message is presented in the user interface with a higher display precedence than indications of senders of received messages in the thread from unimportant users. The list of persons that are important to the user may be imported from a user profile external to the email application program, may be configured by the user within the email application, or may be automatically configured by the email application based on frequency of messages sent to and/or received from different users.

In particular, an indication of a message sender that is an important person may be displayed with a higher precedence than one or more indications of other message senders that are not important persons, by displaying the indication of the important person sender relatively closer to the front or top of a list of message senders associated with the thread.

In another embodiment, the sender of a received message in a thread is also compared with the senders of previous messages in the thread. If the received message is the first message received from that sender, then the message is considered a message from a new participant that is joining the message thread, and the message sender is displayed in the user interface with a higher display precedence than senders that have previously sent one or more messages in the thread. For example, a sender that is a new participant in a message thread may be presented with a higher display precedence than senders that have previously joined the thread by displaying the new participant sender relatively closer to the front or top of a list of senders associated with the thread. A sender may be considered to be a new participant in a thread until the first message received from them is read by the local user, and a subsequent message is received from them as well.

The disclosed system may be embodied such that important person senders are displayed at a relatively higher display precedence than new thread participant senders, which in turn may be displayed at a higher precedence than all other senders in the thread. Moreover, senders of unread messages may be displayed at higher positions within a display precedence than senders of messages that have already been read.

In this way there is disclosed a new system for providing a gathered threads view that displays indications of messages received from important users and new thread participants so that the user is conveniently made aware of the presence of such messages in a thread without having to expand the view of the thread to display all messages in the thread.

### BRIEF DESCRIPTION OF THE DRAWINGS

In order to facilitate a fuller understanding of the present invention, reference is now made to the appended drawings. These drawings should not be construed as limiting the present invention, but are intended to be exemplary only.

FIG. 1 is a simplified screen shot showing a gathered threads view in a prior art user interface to an email application;

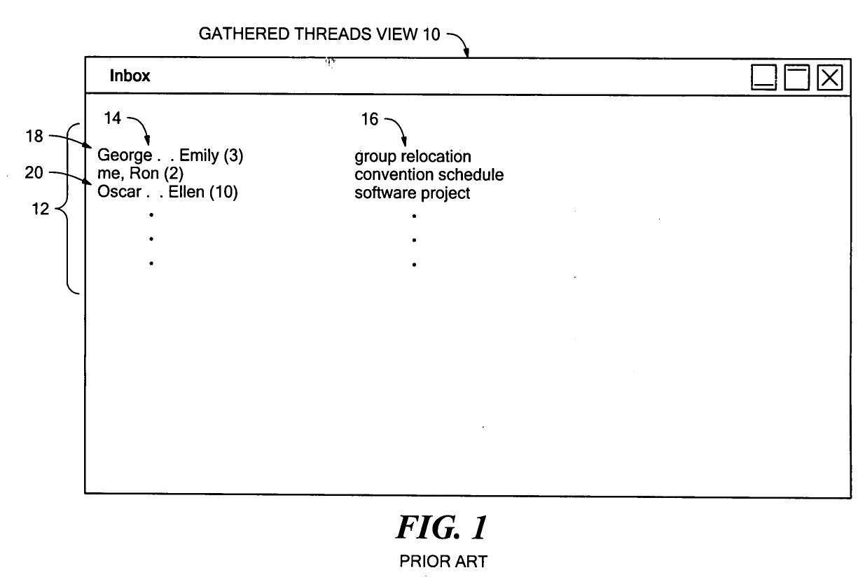

FIG. 2 is a block diagram showing software components in an illustrative embodiment of the disclosed system;

FIG. 3 is a flow chart showing steps performed in an illustrative embodiment of the disclosed system; and

FIG. 4 is a simplified screen shot showing a gathered threads view in a user interface to an email application in an illustrative embodiment of the disclosed system.

### DETAILED DESCRIPTION OF EXEMPLARY EMBODIMENTS

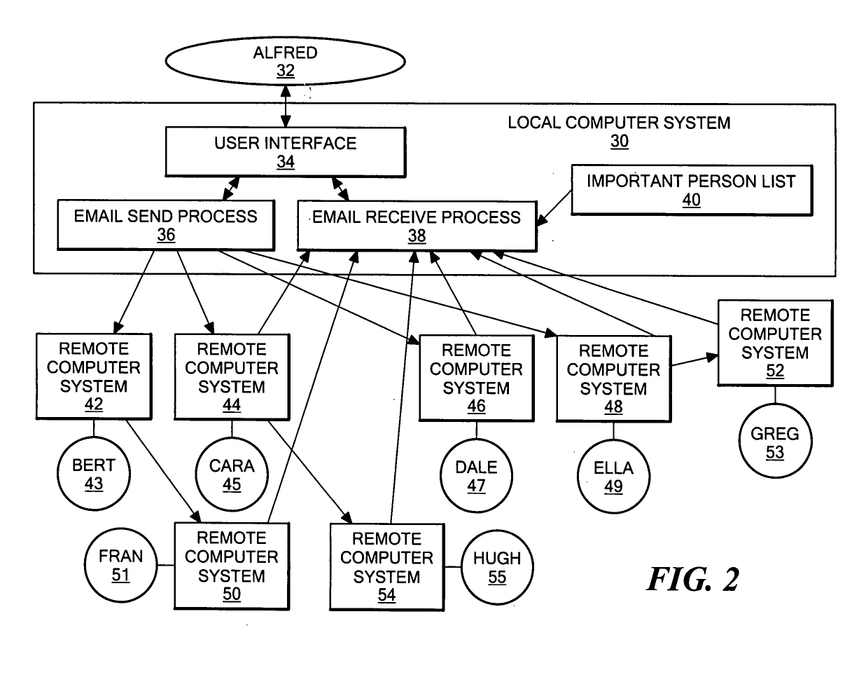

As shown in FIG. 2, an illustrative embodiment of the disclosed system operates using a number of software components executing on at least one local computer system, shown for purposes of illustration as the local computer system 30, and remote computer systems 42, 44, 46, 48, 50, 52 and 54. The local computer system 30, and remote computer systems 42, 44, 46, 48, 50, 52 and 54, may each, for example, include at least one processor, program storage, such as memory, for storing program code executable on the processor, and one or more input/output devices and/or interfaces, such as data communication and/or peripheral devices and/or interfaces. The local computer system 30 and remote computer systems 42, 44, 46, 48, 50, 52 and 54 are communicably connected by a communication network 22, such as a Local Area Network (LAN), the Internet, or the like. The local computer system 30 and remote computer systems 42, 44, 46, 48, 50, 52 and 54 may each further include appropriate operating system software.

As further shown in FIG. 2 an email send software process 36 and email receive software process 38 executing on the local computer system 30 operate to send and receive email messages respectively, and to provide the user interface 34 to the local user Alfred 32. The email receive process 38 further has access to an important person list 40. The email send process 36 and email receive process 38 may, for example, be part of an email client application program that uses a messaging system based on a protocol such as the Simple Mail Transfer Protocol (SMTP). The important person list 40 includes indications of persons that are important to the local user Alfred 32. Such indications may, for example, consist of email addresses, user names, or other types of indications of important persons. The important person list 40 may be defined by the local user Alfred 32 through the user interface 34, or may be defined using an application external to the email processes 36 and 38. The important person list 40 may further be automatically determined by the email processes 36 and 38 based on the frequency of email messages sent to and/or received from different users. For example, the important person list may consist of those users that the local user Alfred 32 sent the most email messages to over the last month.

The user interface 34 includes a gathered threads view in which multiple messages in a message thread are displayed using a single entry in a list of message thread entries, and/or by a group of adjacent message entries corresponding to the multiple messages in the message thread, or in some other way that gathers indications of the multiple messages into a corresponding region of the user interface 34. For example, the list of message thread entries in the gathered threads view provided in the user interface 34 may be presented in a display of the local user Alfred 32's Inbox message structure that shows messages received by the email receive process 38.

For purposes of explanation, an example of operation of the embodiment shown in FIG. 2 is now described. First, the local user Alfred 32 composes an email message that is sent using the email send process 36 to the remote users Bert 43, Cara 45, Dale 47 and Ella 49 that are associated with the remote computer systems 42, 44, 46 and 48 respectively. This email message is the first email message in a message thread, and may be referred to as the root or original message in the thread. Bert 43, Cara 45, Dale 47 and Ella 49 are the recipients of the original message of the thread, and some number of reply messages are received from them by the email receive process 38 during an initial time period in the example of FIG. 2. At some point, Bert 42 adds Fran 51 to the recipients of a thread message, for example by putting Fran 51 in the CC: field of a reply to the original message from Alfred 32, or of a reply to another message in the thread, who is a remote user associated with the remote computer system 50. Similarly, at some point Cara 45 adds Hugh 55 to the recipients of a thread message, for example by adding Hugh 55 to the CC: field of a reply to the original message or a subsequent message in the thread, and Ella 49 also adds Greg 53 to the recipients of a message in the thread, for example by adding Greg 53 to the CC: field of a reply to the original message or a subsequent message in the thread.

After the initial period in which replies in the thread were previously received by the email receive process 38 from Bert 43, Cara 45, Dale 47 and Ella 49, and these previously received replies have been read by Alfred 32, the email receive process 38 receives a new set of reply messages in the thread from the remote users shown in FIG. 2 in the following order:

1. response message from Cara 45

2. response message from Hugh 55

3. response message from Ella 49

4. response message from Greg 53

5. response message from Fran 51

6. response message from Dale 47

The above response messages may, for example, be generated by each of the remote users using a Reply All option in an email client application executing on the corresponding remote computer system, or through any other appropriate mechanism for providing a new message in a message thread. As each of the above listed response messages are received, the disclosed system checks the important person list 40 to determine if the sender is an important person to the local user Alfred 32. If a sender is listed in the important person list 40, then the received message is displayed at a highest display precedence. The disclosed system further checks the sender of each received message to determine if the sender is a new participant in the message thread. A new participant in the message thread is a user that has not previously sent a message in the thread.

In the example of FIG. 2, the important person list 40 is assumed to include an indication of Hugh 55, but no indication of any of the other senders. Accordingly, the message received from Hugh 55 is given the highest display precedence. Additionally, the messages from Fran 51 and Greg 53 are identified as messages from new participants in the thread, and are therefore given a higher display precedence than the messages from Cara 45, Ella 48, and Dale 47, even though the most recent messages from Cara 45 and Ella 48 were received before the messages from Fran 51 and Greg 53. Note that the mot recent messages received from Cara 45, Ella 48 and Dale 47 are not considered messages from a new participant, since previous messages from those users were received by the email receive process 38 and read by the local user Alfred 32. Also note that the message from Hugh 55 is not given the second highest display precedence, even though the message from Hugh 55 is the first message in the thread received from Hugh 55, since the message instead is given the highest display precedence based on the fact the Hugh is indicated in the important person list 40. Thus the illustrative embodiment described with reference to FIG. 2 assigns only the highest display precedence to a given message that the message qualifies for.

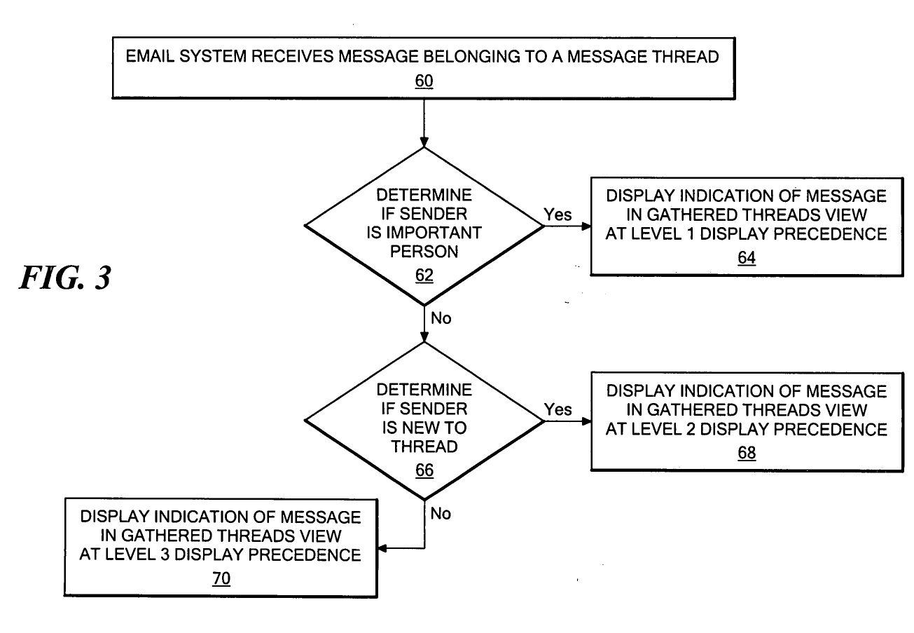

FIG. 3 is a flow chart showing steps performed in an illustrative embodiment. As shown in FIG. 3, at step 60, the disclosed system receives a message belonging to a message thread. For example, a received message may be considered to belong to a message thread if the received message is a response to a previous message in the thread, or if it contains the original message of the thread, or if it has the same subject as the original message of the thread. At step 62, the disclosed system determines if the sender of the received message is an important person with regard to a local user. For example, the disclosed system may compare the sender of the received message to a list of important persons maintained on or accessible to a local computer system.

If it is determined that the sender of the received message is an important person, then step 62 is followed by step 64, in which an indication of the received message is displayed in a gathered threads view at a highest display precedence, for example a level 1 display precedence. Otherwise, step 62 is followed by step 66, in which the disclosed system determines whether the received message is from a new participant in the message thread. A sender of a received message may be considered a new participant in the message thread if the sender if no messages have been previously received from the sender. If the sender of the received message is determined to be a new participant in the message thread, then step 66 is followed by step 68, in which an indication of the received message is displayed in a gathered threads view at a second highest display precedence, for example a level 2 display precedence. Otherwise, at step 70 the received message is displayed in a gathered threads view at a lower display precedence, for example at a level 3 display precedence.

As a result of the steps shown in FIG. 3, indications of received messages in a message thread may be organized in a senders list in which those received messages displayed at level 1 display precedence are located at the top or front of the list, followed by received messages displayed at level 2 display precedence, followed by some representation of all or some of the received messages displayed at level 3 display precedence. Within each display precedence, indications of received messages may, for example, be displayed in the order of receipt, such that messages received before other messages at the same display precedence are located more towards the top or front of the list, or in reverse order of receipt.

The display precedence of a received message may be lowered after the initial precedence determination based on various specific events, such as whether the local user has read the message, whether another message is received from the same sender, etc. For example, in the illustrative embodiment of FIG. 3, a message remains at level 2 display precedence until it has been read by the local user, and another message in the thread is received from the same sender, at which time the message is changed to level 3 precedence. In another possible alternative embodiment, all messages that have been read by the local user may be changed from display precedence 1 or display precedence 2 to display precedence 3.

The elements of the senders list may consist of the names of the senders of the corresponding messages. A gathered threads view provided by the disclosed system may display only a subset of the message senders for a given thread, since the number of messages in a thread may grow quite large. In such a case, the subset of senders displayed would consist of some number of indications located most closely to the top or front of the list. For example, the displayed system may be embodied such that in the event of a space constraint on the total number of senders in the sender list that can be displayed, all or at least some predetermined number of senders at level 1 display precedence are always displayed, all or at least some minimum number of senders at level 2 display precedence are always displayed, but only the first, last, or first and last senders at level 3 display precedence are always displayed. Alternatively, some number of the first and/or last senders at level 3 display precedence may be displayed up to a limit based on the available display space and/or total number of senders in the senders list.

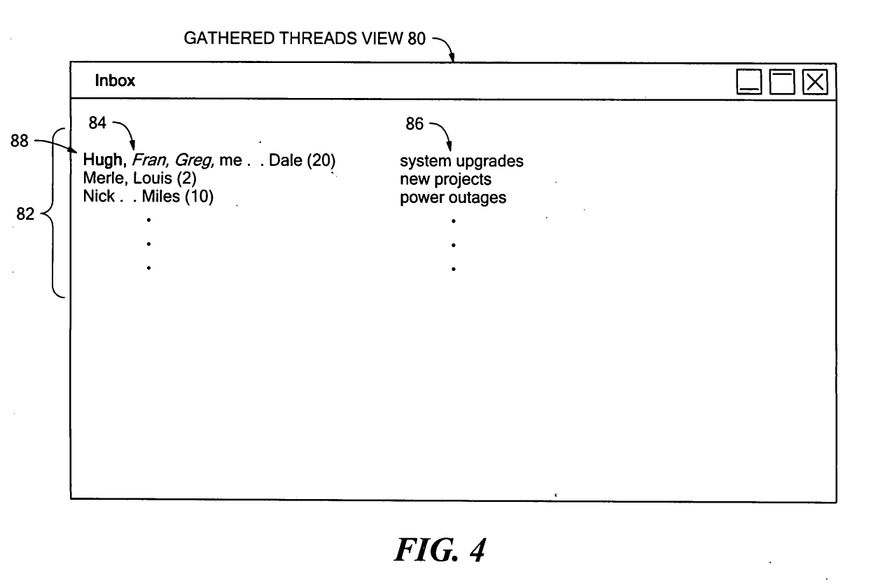

FIG. 4 is a simplified screen shot 80 showing a gathered threads view in a user interface to an email application in an illustrative embodiment. As shown in FIG. 4, a thread list 82 contains multiple message thread entries, each of which represents multiple received messages belonging to a message thread. Each entry in the thread list 82 includes a sender list 84 displaying user names of senders of at least some of the received messages in the thread. A number in parenthesis at the end of each sender list 84 indicates the total number of messages in the thread. The displayed sender list 84 for a given entry in the thread list 82 may sometimes only represent a subset of the total number of messages in the thread.

The message thread entry 88 represents a message thread resulting from the series of messages described above with reference to operation of the illustrative embodiment of FIG. 2. The message thread represented by the entry 88 includes twenty (20) received messages. The list of senders for the entry 88 is shown by the sender list 84, in which the front or top of the list 84 is located at the left hand side. As described above with reference to the example of FIG. 2, the indication of the received message from Hugh is displayed with a highest level display precedence, since Hugh is contained in the local user's important person list. As a result, indication of the received message from Hugh is displayed as the user name “Hugh” in the first position of the sender list 84 for entry 88. In the example of FIG. 4, for purposes of illustration, the text “Hugh” is bolded to conveniently provide a visual indication that that corresponding message in the thread was sent by an important person, and that accordingly the sender is being displayed at level 1 display precedence. However, the present invention is not limited to such an embodiment, and the important persons in the sender list 84 may be indicated using any appropriate visual attributes associated with highest display precedence messages in a given embodiment, including but not limited to a font, style or color associated with the highest display precedence. Alternatively, the senders for highest precedence messages may be simply be displayed using the same visual attributes as all other senders in the sender list 84.

Since the messages received from Fran and Greg were determined to be messages from new participants joining the thread, indications of the received messages from Fran and Greg are displayed at level 2 display precedence, in this case in the second and third positions of the sender list 84 for entry 88. In the example of FIG. 4, for purposes of illustration, the text “Fran” and “Greg” is italicized to conveniently provide a visual indication that that corresponding messages in the thread were sent by new participants in the thread, and that accordingly the senders are being displayed at level 2 display precedence. However, the present invention is again not limited to such an embodiment, and the new participants in the sender list 84 may be indicated using any appropriate visual attributes for a given embodiment, including but not limited to a font, style or color associated with indications of messages from new thread participants. Alternatively, senders of messages from new thread participants may be simply be displayed using the same font or color as all other senders in the sender list 84.

Following the indications of the messages from new thread participants Fran and Greg is an indication of the messages at level 3 precedence, shown by the text “me . . . Dale”. The text “me” is an indication of the first or original message in the thread, in this case sent by the local user Alfred 32 (FIG. 2), and the text “Dale” indicates the last or most recent message received in the thread. Alternatively, the messages at level 3 precedence may be represented by one or more senders of the first messages in the thread, one or more senders of the last messages in the thread, or in some other manner.

While the message indications in the sender list 84 are shown for purposes of illustration as user names, the disclosed system is not so limited, and other specific types of indications may be used consistent with principles of the invention. Additionally, those skilled in the art will recognize that the simplified screen shot 80 is provided only for purposes of convenient explanation, and that many user interface display elements in addition to those shown in FIG. 4 may be included in an actual implementation of an electronic mail user interface. It will also be recognized that various specific interface mechanisms may be provided with an embodiment of the disclosed system to enable the user to expand a view of a thread, and/or to access the content of specific messages in a thread. For example, one embodiment of the disclosed system enables a user to click on one of the user names in the sender list 84 for a given thread entry to access the corresponding message, and/or to expand the view to show summary representations of all messages in the thread.

FIGS. 2 and 3 are block diagram and flowchart illustrations of methods, apparatus(s) and computer program products according to an embodiment of the invention. It will be understood that each block of FIGS. 2 and 3, and combinations of these blocks, can be implemented by computer program instructions. These computer program instructions may be loaded onto a computer or other programmable data processing apparatus to produce a machine, such that the instructions which execute on the computer or other programmable data processing apparatus create means for implementing the functions specified in the block or blocks. These computer program instructions may also be stored in a computer-readable-memory that can direct a computer or other programmable data processing apparatus to function in a particular manner, such that the instructions stored in the computer-readable memory produce an article of manufacture including instruction means which implement the function specified in the block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the block or blocks.

Those skilled in the art should readily appreciate that programs defining the functions of the present invention can be delivered to a computer in many forms; including, but not limited to: (a) information permanently stored on non-writable storage media (e.g. read only memory devices within a computer such as ROM or CD-ROM disks readable by a computer I/O attachment); (b) information alterably stored on writable storage media (e.g. floppy disks and hard drives); or (c) information conveyed to a computer through communication media for example using wireless, baseband signaling or broadband signaling techniques, including carrier wave signaling techniques, such as over computer or telephone networks via a modem.

While the invention is described through the above exemplary embodiments, it will be understood by those of ordinary skill in the art that modification to and variation of the illustrated embodiments may be made without departing from the inventive concepts herein disclosed. Moreover, while the preferred embodiments are described in connection with various illustrative program command structures, one skilled in the art will recognize that they may be embodied using a variety of specific command structures.

We claim:

1. A method for providing a gathered threads view in a user interface to an electronic messaging system, comprising:
receiving a message belonging to a message thread;
determining whether a sender of said message is an important person with regard to a local receiving user; and
in the event that said sender of said message is an important person with regard to said local receiving user, displaying an indication of said sender of said message at a higher precedence than indications of senders of other messages in said message thread that are not important persons with regard to said local receiving user.

2. The method of claim 1, wherein said other messages include at least one message received subsequently to said message determined to have a sender that is said important person with regard to said local receiving user.

3. The method of claim 1, further comprising:
in the event that said sender of said message is not an important person with regard to said local receiving user, determining whether said sender of said message has sent a previously received message in said message thread; and
in the event that said sender of said message is not an important person with regard to said local receiving user and said sender of said message has not sent any previously received message in said message thread, displaying an indication of said sender of said message at a higher precedence than indications of senders of other messages in said message thread whose senders have sent a plurality of received messages in said message thread.

4. The method of claim 3, wherein said other messages whose senders have sent a plurality of received messages in said message thread include at least one message received subsequently to said message determined to have a sender that has not sent at least one previously received message in said message thread.

5. The method of claim 1, wherein said displaying said indication of said sender of said message at a higher precedence than indications of senders of other messages in said message thread comprises displaying said indication of said sender of said message as an associated user name in front of other user names corresponding to said other messages in a list of user names displayed to represent messages in said message thread.

6. The method of claim 3, further comprising, in the event that said sender of said message is not an important person with regard to said local receiving user and said sender of said message has not sent at least one previously received message in said message thread, displaying said indication of said sender of said message at a higher precedence than indications of senders of other messages in said message thread by displaying said indication of said sender of said message as an associated user name in front of other user names corresponding to said other messages in a list of user names displayed to represent messages in said message thread.

7. The method of claim 1 wherein said gathered threads view includes a list of thread entries, wherein each of said thread entries represents all messages in an associated message thread, and wherein each said thread entry includes a user name list displaying a user name of a sending user for each received message in the message thread.

8. The method of claim 7, further comprising displaying only a predetermined number of user names contained in said user name list.

9. A system including a computer readable medium, said computer readable medium having program code stored thereon for providing a gathered threads view in a user interface to an electronic messaging system, said program code comprising:
program code for receiving a message belonging to a message thread;
program code for determining whether a sender of said message is an important person with regard to a local receiving user; and
program code for, in the event that said sender of said message is an important person with regard to said local receiving user, displaying an indication of said sender of said message at a higher precedence than indications of senders of other messages in said message thread that are not important persons with regard to said local receiving user.

10. The system of claim 9, wherein said other messages include at least one message received subsequently to said message determined to have a sender that is said important person with regard to said local receiving user.

11. The system of claim 9, said program code further comprising:
program code for, in the event that said sender of said message is not an important person with regard to said local receiving user, determining whether said sender of said message has sent a previously received message in said message thread; and
in the event that said sender of said message is not an important person with regard to said local receiving user and said sender of said message has not sent any previously received message in said message thread, displaying an indication of said sender of said message at a higher precedence than indications of senders of other messages in said message thread whose senders have sent a plurality of received messages in said message thread.

12. The system of claim 11, wherein said other messages whose senders have sent a plurality of received messages in said message thread include at least one message received subsequently to said message determined to have a sender that has not sent at least one previously received message in said message thread.

13. The system of claim 9, wherein said program code for displaying said indication of said sender of said message at a higher precedence than indications of senders of other messages in said message thread comprises program code for displaying said indication of said sender of said message as an associated user name in front of other user names corresponding to said other messages in a list of user names displayed to represent messages in said message thread.

14. The system of claim 11, further comprising, program code for, in the event that said sender of said message is not an important person with regard to said local receiving user and said sender of said message has not sent at least one previously received message in said message thread, displaying said indication of said sender of said message at a higher precedence than indications of senders of other messages in said message thread by displaying said indication of said sender of said message as an associated user name in front of other user names corresponding to said other messages in a list of user names displayed to represent messages in said message thread.

15. The system of claim 9 wherein said gathered threads view includes a list of thread entries, wherein each of said thread entries represents all messages in an associated message thread, and wherein each said thread entry includes a user name list displaying a user name of a sending user for each received message in the message thread.

16. The system of claim 15, further comprising program code for displaying only a predetermined number of user names contained in said user name list.

17. A computer program product including a computer readable medium, said computer readable medium having program code stored thereon for providing a gathered threads view in a user interface to an electronic messaging system, said program code comprising:
program code for receiving a message belonging to a message thread;
program code for determining whether a sender of said message is an important person with regard to a local receiving user; and
program code for, in the event that said sender of said message is an important person with regard to said local receiving user, displaying an indication of said sender of said message at a higher precedence than indications of senders of other messages in said message thread, wherein said senders of said other messages are not important persons with regard to said local receiving user.

18. A computer data signal embodied in a carrier wave, said computer data signal having program code stored thereon for providing a gathered threads view in a user interface to an electronic messaging system, said program code comprising:
program code for receiving a message belonging to a message thread;
program code for determining whether a sender of said message is an important person with regard to a local receiving user; and
program code for, in the event that said sender of said message is an important person with regard to said local receiving user, displaying an indication of said sender of said message at a higher precedence than indications of senders of other messages in said message thread, wherein said senders of said other messages are not important persons with regard to said local receiving user.

19. A system for providing a gathered threads view in a user interface to an electronic messaging system, said program code comprising:
means for receiving a message belonging to a message thread;
means for determining whether a sender of said message is an important person with regard to a local receiving user; and
means for, in the event that said sender of said message is an important person with regard to said local receiving user, displaying an indication of said sender of said message at a higher precedence than indications of senders of other messages in said message thread, wherein said senders of said other messages are not important persons with regard to said local receiving user.
